(19) United States
(12) Patent Application Publication
(10) Pub. No.: US 2015/0063301 A1
(43) Pub. Date: Mar. 5, 2015

(54) OPERATOR CONTROLLED APN ROUTING MAPPING

(71) Applicant: QUALCOMM Incorporated, San Diego, CA (US)

(72) Inventor: Stefano Faccin, Hayward, CA (US)

(21) Appl. No.: 14/476,008

(22) Filed: Sep. 3, 2014

Related U.S. Application Data
(60) Provisional application No. 61/873,810, filed on Sep. 4, 2013.

(51) Int. Cl. H04W 16/08; H04W 36/18; H04W 8/02

(52) U.S. Cl. CPC H04W 16/08; H04W 8/02; H04W 36/18
USPC 370/331; 370/328

(57) ABSTRACT

Systems and methods for operator controlled APN routing mapping are described herein. In one embodiment, a method for routing policy evaluation in a wireless communication system comprises receiving, from a home network, a message comprising a home network policy associated with network node routing, and receiving, from a visited network, another message comprising a visited network policy associated with network node routing. The method also comprises evaluating the home network policy to determine whether to route data traffic via one of a wireless node offload or a designated access point name (APN), evaluating the home network policy to determine whether the home network policy has priority over the visited network policy, and ignoring a rule of the visited network policy associated with routing the data traffic in response to a determination that the home network policy has priority.

### RELATED APPLICATION

This application claims priority under 35 U.S.C. §119(e) to U.S. Provisional Application No. 61/873,810 filed on Sep. 4, 2013, the entire specification of which is incorporated herein by reference.

### FIELD

Aspects of the present disclosure relate generally to wireless communication systems, and more particularly, to access point name (APN) route mapping.

### BACKGROUND

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of access points that can support communication for a number of mobile devices, such as, for example, mobile stations (STA), laptops, cell phones, PDAs, tablets, etc. A mobile device may communicate with an access point via the downlink (DL) and uplink (UL). The DL (or forward link) refers to the communication link from the access point to the mobile device, and the UL (or reverse link) refers to the communication link from the mobile device to the access point.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to an aspect, a method for routing policy evaluation in a wireless communication system is described herein. The method comprises receiving, from a home network, a message comprising a home network policy associated with network node routing, and receiving, from a visited network, another message comprising a visited network policy associated with network node routing. The method also comprises evaluating the home network policy to determine whether to route data traffic via one of a wireless node offload or a designated access point name (APN), evaluating the home network policy to determine whether the home network policy has priority over the visited network policy, and ignoring a rule of the visited network policy associated with routing the data traffic in response to a determination that the home network policy has priority.

A second aspect relates to an apparatus for routing policy evaluation in a wireless communication system. The apparatus comprises means for receiving, from a home network, a message comprising a home network policy associated with network node routing, and means for receiving, from a visited network, another message comprising a visited network policy associated with network node routing. The apparatus also comprises means for evaluating the home network policy to determine whether to route data traffic via one of a wireless node offload or a designated access point name (APN), means for evaluating the home network policy to determine whether the home network policy has priority over the visited network policy, and means for ignoring a rule of the visited network policy associated with routing the data traffic in response to a determination that the home network policy has priority.

A third aspect relates to an apparatus. The apparatus comprises a transceiver configured to receive, from a home network, a message comprising a home network policy associated with network node routing, and receive, from a visited network, another message comprising a visited network policy associated with network node routing. The apparatus also comprises at least one processor configured to evaluate the home network policy to determine whether to route data traffic via one of a wireless node offload or a designated access point name (APN), evaluate the home network policy to determine whether the home network policy has priority over the visited network policy, and ignore a rule of the visited network policy associated with routing the data traffic in response to a determination that the home network policy has priority. The apparatus further comprises a memory coupled to the at least one processor for storing data.

A fourth aspect relates to a computer program product. The computer program product comprising computer-readable medium storing code for causing at least one processor to receive, from a home network, a message comprising a home network policy associated with network node routing, and receive, from a visited network, another message comprising a visited network policy associated with network node routing. The computer program product also comprises code for causing the at least one processor to evaluate the home network policy to determine whether to route data traffic via one of a wireless node offload or a designated access point name (APN), evaluate the home network policy to determine whether the home network policy has priority over the visited network policy, and ignore a rule of the visited network policy associated with routing the data traffic in response to a determination that the home network policy has priority.

### BRIEF DESCRIPTION OF THE DRAWINGS

FIG. 1 is a block diagram conceptually illustrating an example of a telecommunications system.

FIG. 2 is a block diagram conceptually illustrating a design of a base station/eNB and a UE configured according to one aspect of the present disclosure.

FIG. 3A is a block diagram conceptually illustrating an example wireless communication system including a WLAN and a wireless network.

FIGS. 3B-C are block diagrams conceptually illustrating example policies including a flag and/or list of PLMNs.

FIG. 4 illustrates embodiments of methodologies for routing policy evaluation.

FIG. 5 illustrates an example apparatus for implementing the methodology of FIG. 4.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

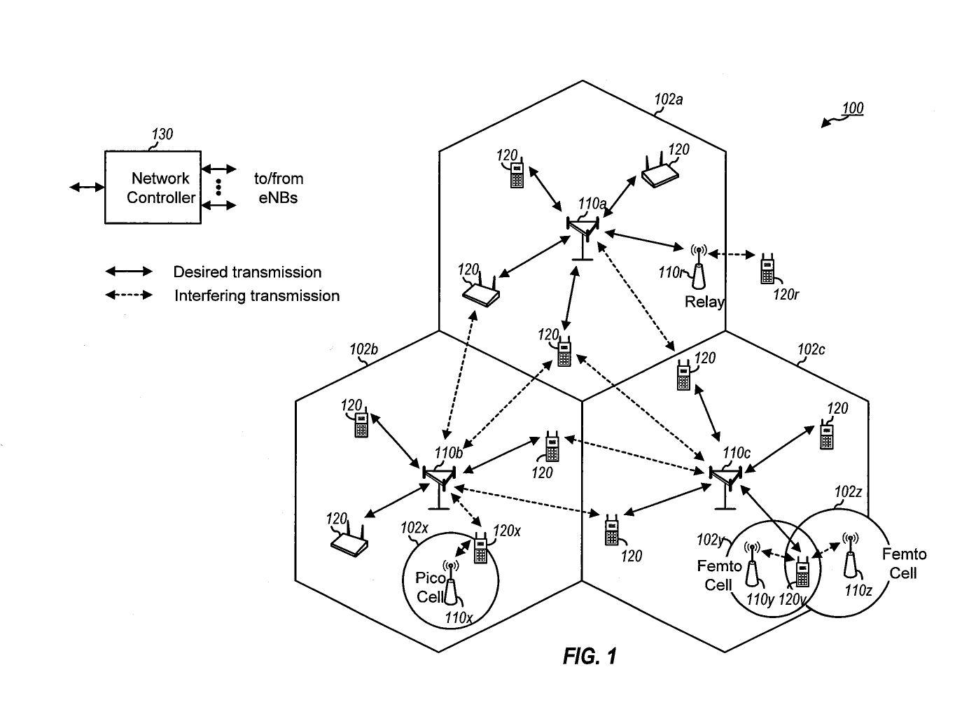

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB (HNB). In the example shown in FIG. 1, the eNBs 110a, 110b and 110c may be macro eNBs for the macro cells 102a, 102b and 102c, respectively. The eNB 110x may be a pico eNB for a pico cell 102x, serving a UE 120x. The eNBs 110y and 110z may be femto eNBs for the femto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. Broadcast multicast operations may require synchronization of base stations within a defined area, but the present technology is not limited thereby. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, or other mobile devices. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

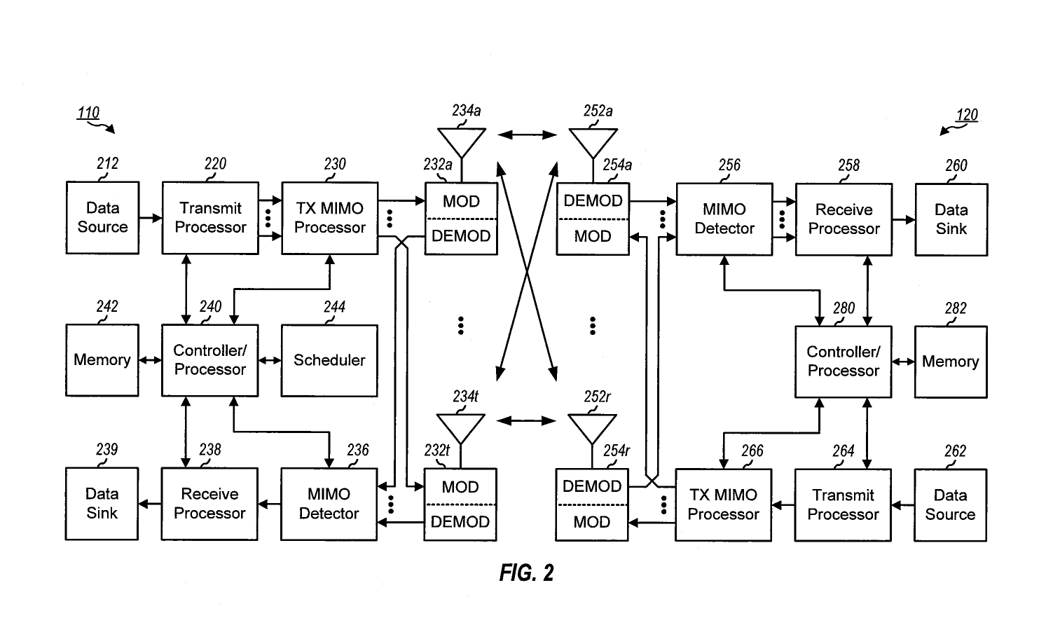

FIG. 2 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 234a through 234t, and the UE 120 may be equipped with antennas 252a through 252r.

At the base station 110, a transmit processor 220 may receive data from a data source 212 and control information from a controller/processor 240. The control information may be for the PBCH, PCFICH, PHICH, PDCCH, etc. The data may be for the PDSCH, etc. The processor 220 may process (e.g., encode and symbol map) the data and control information to obtain data symbols and control symbols, respectively. The processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 120, the antennas 252a through 252r may receive the downlink signals from the base station 110 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at the UE 120, a transmit processor 264 may receive and process data (e.g., for the PUSCH) from a data source 262 and control information (e.g., for the PUCCH) from the controller/processor 280. The processor 264 may also generate reference symbols for a reference signal. The symbols from the transmit processor 264 may be precoded by a TX MIMO processor 266 if applicable, further processed by the modulators 254a through 254r (e.g., for SC-FDM, etc.), and transmitted to the base station 110. At the base station 110, the uplink signals from the UE 120 may be received by the antennas 234, processed by the demodulators 232, detected by a MIMO detector 236 if applicable, and further processed by a receive processor 238 to obtain decoded data and control information sent by the UE 120. The processor 238 may provide the decoded data to a data sink 239 and the decoded control information to the controller/processor 240.

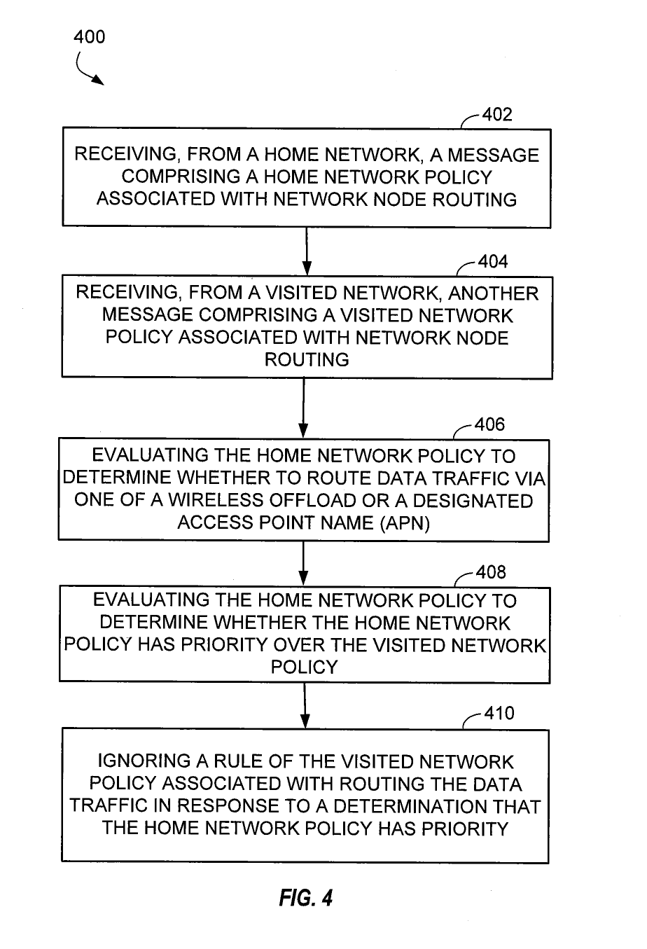

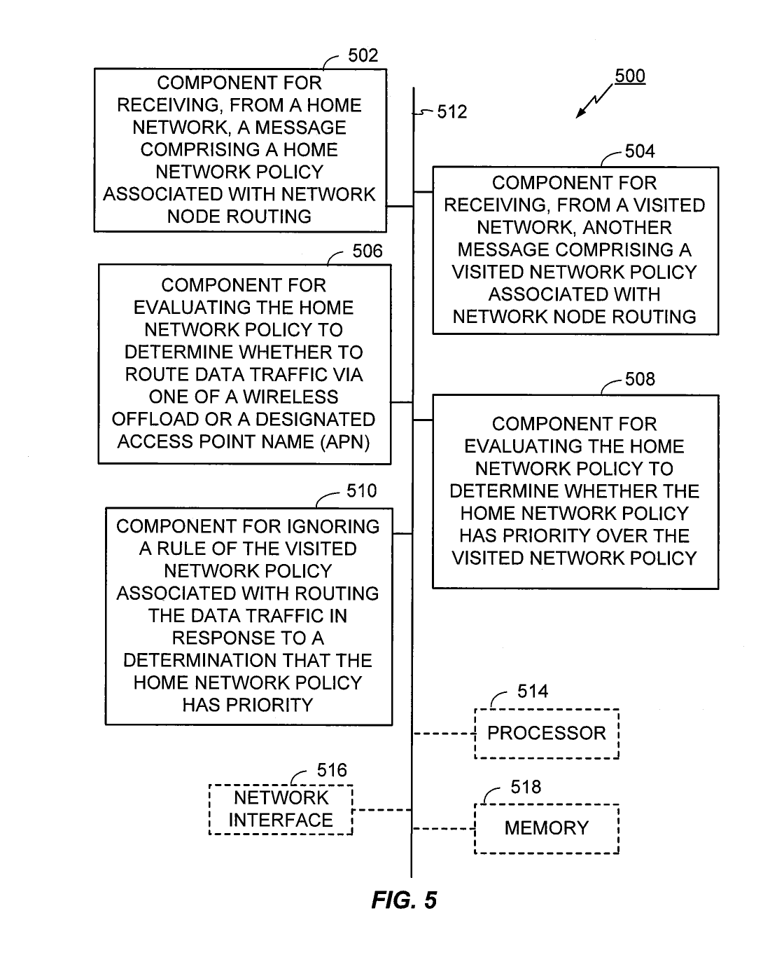

The controllers/processors 240 and 280 may direct the operation at the base station 110 and the UE 120, respectively. The processor 240 and/or other processors and modules at the base station 110 may perform or direct the execution of various processes for the techniques described herein. The processor 280 and/or other processors and modules at the UE 120 may also perform or direct the execution of the functional blocks illustrated in FIGS. 4 and 5, and/or other processes for the techniques described herein. The memories 242 and 282 may store data and program codes for the base station 110 and the UE 120, respectively. A scheduler 244 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 280, the memory 282, the receive processor 258, the MIMO detector 256, the demodulators 254a, and the antennas 252a configured to perform the functions recited by the aforementioned means. In another aspect, the aforementioned means may be a module or any apparatus configured to perform the functions recited by the aforementioned means.

One mechanism to facilitate high bandwidth communication for multimedia has been single frequency network (SFN) operation. Particularly, Multimedia Broadcast Multicast Service (MBMS) and MBMS for LTE, also known as evolved MBMS (eMBMS) (including, for example, what has recently come to be known as multimedia broadcast single frequency network (MBSFN) in the LTE context), can utilize such SFN operation. SFNs utilize radio transmitters, such as, for example, eNBs, to communicate with subscriber UEs. Groups of eNBs can transmit information in a synchronized manner, so that signals reinforce one another rather than interfere with each other. In the context of eMBMS, the shared content is transmitted from multiple eNB's of a LTE network to multiple UEs. Therefore, within a given eMBMS area, a UE may receive eMBMS signals from any eNB (or eNBs) within radio range. However, to decode the eMBMS signal each UE receives Multicast Control Channel (MCCH) information from a serving eNB over a non-eMBMS channel. MCCH information changes from time to time and notification of changes is provided through another non-eMBMS channel, the PDCCH. Therefore, to decode eMBMS signals within a particular eMBMS area, each UE is served MCCH and PDCCH signals by one of the eNBs in the area.

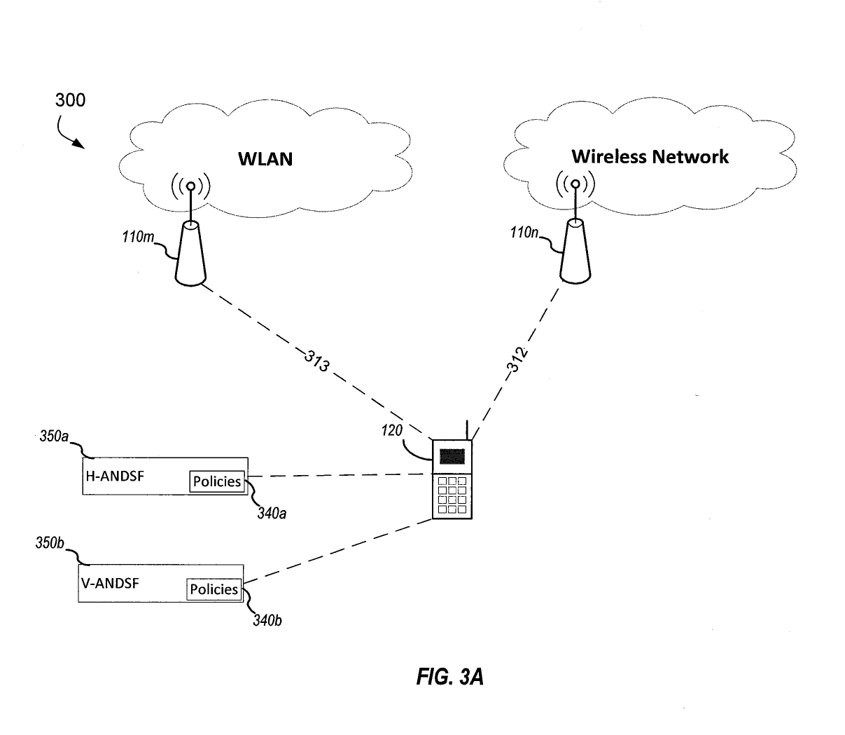

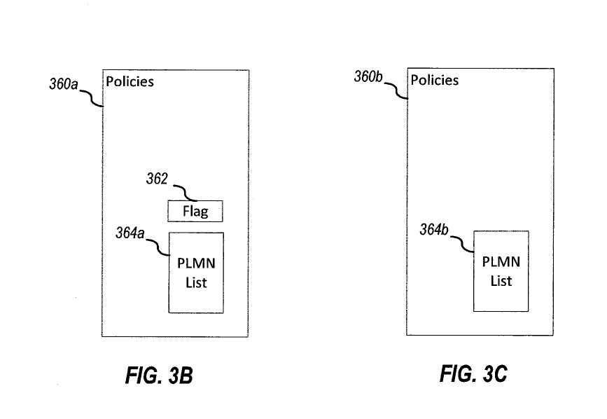

FIG. 3A illustrates an example of a wireless communication system 300 including a wireless local area network (WLAN) and a wireless network (e.g., LTE network). For example, with reference to the example system 300 shown in FIG. 3A, a 3rd Generation Partnership Project (3GPP) Evolved Packet System (EPS) network has the UE 120 connected to both a LTE (3GPP EPS) network node 110n and a WLAN node 110m via a first communication link 312 and a second communication link 313, respectively. The UE 120 may be provided with policies 340a, 340b. For example, the UE 120 may receive one set of policies 340a from a home Access Network Discovery and Selection Function (ANDSF) (H-ANDSF) 350a, and may receive another set of policies 340b from a visited ANDSF 350b (V-ANDSF). The UE 120 may be in communication with either, both, or neither of the nodes 110n, 110m. One skilled in the art would understand that although two communication links are described, the present disclosure is not limited to the two communication links. Another number of communication links may be used without affecting the scope or spirit of the present disclosure.

In one example, the components or modules of the network providing the policies 340 may include an ANDSF entity or module 350 (e.g., one of 350a or 350b). In one example, the ANDSF 350 may communicate with the UE 120 using an Open Mobile Alliance Device Management (OMA-DM) protocol or the like. Based on OMA-DM specifications, the information exchanged by the UE 120 and the ANDSF 350 may be defined in a Management Object (MO). For example, the MO for ANDSF to UE communication may be specified in the 3GPP Technical Specification TS24.312 or the like.

The ANDSF 350 may provide inter-access point name (APN) routing policies (IARP). The IARP may be provisioned by the H-ANDSF 350a. An IARP routing capable UE (e.g., UE 120) may select an existing internet protocol (IP) interface, which may be associated with a specific APN, to route IP flows based on the received/provisioned IARP and user preferences. In another example, the IP interface may be used for non-seamless WLAN offload (NSWO). Each IP interface that can be selected with IARP may be associated with a different APN or used for NSWO.

An IARP may include the following information: 1) validity conditions, i.e., conditions indicating when the provided policy is valid; and 2) one or more Filter Rules, each one identifying a prioritized list of APNs which may be used by the UE to route IP flows that match specific IP filters (e.g. all flows to a specific transmission control protocol (TCP) port or to a specific destination address, etc.). The Filter Rules may also identify which APNs or interface for non-seamless WLAN offload are restricted for IP flows that match specific IP filters. The IARP routing policy may include filter rules for IARP routing where each filter rule may be associated with a rule priority.

A mapping priority may be provided (e.g., in the IARP). A home public land mobile network (HPLMN) may set the mapping priority to indicate to the UE that the IARP mapping may not be overridden by the active ISRP/inter-system mobility policy (ISMP) rule when ISRP/ISMP is provided by a visited PLMN (VPLMN). The mapping priority may be indicated on a per-PLMN basis. The mapping priority may be provided for the whole policy or applied to each specific Filter Rule.

A filter rule may be applied only when it steers IP traffic to an existing (i.e., already established) packet data network (PDN) connection or via the existing (i.e., already established) interface used for non-seamless WLAN offload. When no APN in the filter rule is associated with an existing PDN connection or with an existing interface used for non-seamless WLAN offload, then the Filter Rule may not be applied.

There may be four types of information provided by the ANDSF 350, i.e., the inter-system mobility policy, the access network discovery information, the inter-system routing policy, and the IARP routing policy. The ANDSF may provide all types of information or only one of them.

The H-ANDSF may select the inter-system mobility policies, the access network discovery information, and the inter-system routing policies to be delivered to the UE according to the operator requirements and the roaming agreements. If the permanent UE identity is known to the H-ANDSF, and subject to operator's configuration, the available subscription data (e.g. the list of access networks, or access technology types, the UE may be authorized to use, etc.) may also be used by the H-ANDSF for selecting the inter-system mobility policies, the access network discovery information, the inter-system routing policies, and the inter-APN routing policies.

The V-ANDSF may select the inter-system mobility policies, the access network discovery information, and the inter-system routing policies to be delivered to the UE according to the operator requirements and the roaming agreements.

If the UE 120 has access network discovery information, inter-system mobility policies or inter-system routing policies valid for its present location, which indicate that there may be an access network in its vicinity with higher priority than the currently selected access network(s), the UE 120 may perform procedures for discovering and reselecting the higher priority access network, if this may be allowed by user preferences. It may be noted that how frequently the UE 120 performs the discovery and reselection procedure depends on the UE 120 implementation.

A UE that is not capable of routing IP traffic simultaneously over multiple radio access interfaces (e.g. a non-IP flow mobility (IFOM) or non-multiple-access PDN connectivity (MAPCON) capable UE, or a UE that has such a capability disabled, or a UE not capable of NSWO) may select the most preferable available access network for inter-system mobility based on the received/provisioned inter-system mobility policies and user preferences and may disregard the inter-system routing policies it may have received from the ANDSF. When automatic access network selection is used, the UE may not initiate a connection to the evolved packet core (EPC) using an access network indicated as restricted by inter-system mobility policies. When the UE selects a non-3GPP radio access as indicated by the preferences in the inter-system mobility policies, the UE may still use 3GPP access for circuit switched (CS) services. It may be noted that a user may manually select the access technology type or access network that may be used by the UE 120. In such a case, the ISMP may not be taken into account.

A UE capable of routing IP traffic simultaneously over multiple radio access interfaces (i.e. an IFOM or MAPCON capable UE, or a UE capable of NSWO) may be pre-provisioned with or may be able to receive from the ANDSF (if the UE supports communication with ANDSF) both inter-system mobility policies and inter-system routing policies. When the UE has the IFOM, the MAPCON and the NSWO capabilities disabled, the UE may select the most preferable available access network based on the received/provisioned inter-system mobility policies and user preferences. When the UE has the IFOM or MAPCON or NSWO capability enabled, the UE may select the most preferable available access networks based on the received/provisioned inter-system routing policies and user preferences. In addition, the UE may route traffic that matches specific IP traffic filters according to the filter rules in the received/provisioned inter-system routing policies and according to the user preferences.

A UE not capable of routing IP traffic simultaneously over multiple radio access interfaces but supporting IARP evaluates the Inter-APN Routing Policies (if any) and determines if any of them match an outgoing IP flow. The highest priority IARP that matches an outgoing IP flow identifies the PDN connection or the interface used for NSWO (the one associated with the preferred APN in the policy) that should be used to route this IP flow.

A UE capable of routing IP traffic simultaneously over multiple radio access interfaces may use the Inter-System Routing Policies (ISRP) and uses also the Inter-APN Routing Policies (if any). The UE may determine how to route an outgoing IP flow by evaluating first the Inter-APN Routing Policies and then the Inter-System Routing Polices. If an IP flow matches an IARP selecting the interface used for NSWO then the UE does not need to evaluate ISRPs for this flow when the IARP is evaluated for this IP flow or at any later time for as long as the active IARP rule maps the IP flow to NSWO. If an IP flow matches an IARP and an ISRP for NSWO then the UE shall apply the matching ISRP. If an IP flow matches an IARP selecting the interface used for an APN and the Mapping Priority in IARP for this IP flow is set by the HPLMN (possibly for the specific VPLN), then the UE may not apply the active ISRP matching this IP flow if the active ISRP rule selects NSWO for the IP flow.

When roaming, it may be possible for the UE to resolve potential conflicts between the policies provided by the H-ANDSF and the policies provided by the V-ANDSF. This applies to both the inter-system mobility policies and to the inter-system routing policies. The UE behavior when receiving policies from H-ANDSF and V-ANDSF may be specified in clause 4.8.0 and in 3GPP TS 24.302 [54].

The ISMP, access network discovery information, ISRP and IARP may also be statically pre-configured by the operator on the UE. The ISMP, access network discovery information, ISRP and IARP provided to the UE by the ANDSF may take precedence over the corresponding policies and access network discovery information pre-configured on the UE.

In one example, IARP may take precedence over ISRP. IARP may be evaluated first, e.g., before ISRP is evaluated. IARP may include NSWO rules. If IARP evaluation selects NSWO, there may be no need to evaluate ISRP for that traffic. If IARP evaluation selects an APN, ISRP may be evaluated and may lead to NSWO.

In some cases, IARP may apply only to existing connections. For example, even if IARP maps traffic or applications to an APN ‘X’, if APN ‘X’ is already connected the mapping may not happen and APN ‘X’ may not be connected as a result of the IARP mapping.

One challenge associated with the routing policy relates to the priority between the ISRP and IARP and the preference between the HPLMN selection for IARP and the VPLMN ANDSF policies. In some cases, 3GPP may specify that VPLMN ANDSF policies have priority over the HPLMN ANDSF policies. Though this may be by design and developed for ISRP and ISMP, it may not always apply to HPLMN IARP versus VPLMN ISRP, as discussed below.

The following requirement may need to be addressed for routing policies. 3GPP TS 23.402 indicates:

When roaming, it shall be possible for the UE to resolve potential conflicts between the policies provided by the H-ANDSF and the policies provided by the V-ANDSF. This applies to both the inter-system mobility policies and to the inter-system routing policies. The UE behaviour when receiving policies from H-ANDSF and V-ANDSF is specified in clause 4.8.0 and in TS 24.302 [54].

However, 3GPP TS 23.402 does not address IARP in the roaming scenario, as it does for the ISRP and ISMP. Operators may prefer the flexibility to prioritize IARP provided by H-ANDSF and define the interaction between the rules IARP provided by H-ANDSF and ISRP/ISMP provided by V-ANDSF.

If the HPLMN needs to map certain types of traffic or applications to a specific APN or NSWO, the HPLMN may not want the VPLMN ISRP policy to override such mapping. For example, some applications may work only over specific APNs, either home routed or not, and therefore that APN may need to be selected. Unless a solution is developed, even if the IARP maps, for example, Application ‘X’ to APN 1, the VPLMN ISRP may instead select to route the traffic for application ‘X’ using WLAN in NSWO, in which case the application may not work. In another example, if the HPLMN desires to offload specific traffic over WLAN in NSWO, so that the traffic does not use cellular resources or traverse the operator core network, the ISRP may override the IARP selection for NSWO and instead transport the traffic over a specific APN, either over cellular or WLAN, that may be home routed (i.e. use a PDN gateway (GW) in the HPLMN).

In accordance with aspects of the subject of this disclosure, there are provided methods and apparatus for data traffic routing based on network policies.

In one aspect, NSWO may be included and specified by IARP. For example, the IARP may include rules and policies associated with NSWO. IARP may take precedence over ISRP. For example, IARP may be evaluated first, prior to evaluation of the ISRP. In some cases, NSWO may be selected only if WLAN is available (and specifically NSWO is already available).

In one embodiment, if the IARP (e.g., from the H-ANDSF) indicates selection of NSWO, then no ISRP rules (e.g., from the V-ANDSF) for that traffic may be applied. For example, the active ISRP rule is not applied. In such cases, the ISRP rule may be ignored. The ISRP rules are not applied until the ISRP validity conditions change and a new ISRP rule becomes valid.

In another embodiment, if the IARP (e.g., from the H-ANDSF) indicates selection of an APN, the ISRP (e.g., from the V-ANDSF) may be evaluated. The active ISRP rule may lead to NSWO. The operator may add an indication to the IARP to indicate priority of the IARP versus ISRP.

In one aspect, if the HPLMN wants the traffic corresponding to the active IARP rule to map to either an APN or NSWO and does not want the VPLMN ISRP to override the mapping, the HPLMN may provide an indication in the IARP rule indicating priority of the IARP. For example, if the indication is provided, then the active ISRP may not override the selection by the IARP. This means that if the IARP selected NSWO, the ISRP may not move such traffic to an APN (either over cellular or WLAN). In this case none of the currently connected APNs is considered suitable for the traffic corresponding to the mapping. If the IARP selected an APN, the ISRP may not move such traffic to NSWO at any time. In this case, NSWO is not considered available for the traffic corresponding to the mapping.

In another aspect, if the HPLMN wants the traffic corresponding to the active IARP rule to map to either an APN or NSWO and wants to allow the VPLMN ISRP to override the mapping, the HPLMN may not provide an indication in the IARP indicating priority of IARP.

In one embodiment, the indication of IARP priority may be a simple flag (e.g., TRUE/FALSE). In this embodiment, a TRUE flag setting may indicate that the IARP from the HPLMN has priority over the ISRP from a VPLMN. In this case, if the IARP selects an APN, the ISRP may not move the corresponding traffic to NSWO, and/or, if the IARP selects NSWO, the ISRP may not move the corresponding traffic to an APN. A FALSE flag setting may indicate that the ISRP is allowed to override IARP mapping. The flag may be included in the IARP from the HPLMN. This embodiment allows a home operator (i.e., operator of the HPLMN) to control whether the ISRP from a VPLMN is allowed to override IARP mapping by setting the flag in the IARP accordingly. For example, if the home operator does not want the ISRP from the VPLMN to override IARP mapping, then the home operator may set the flag to TRUE.

FIG. 3B illustrates an example policy 360a (e.g., IARP) including a flag and list of PLMNs according to an embodiment of the present disclosure. In this embodiment, the indication of IARP priority may include a flag (e.g., TRUE/FALSE) indication 362 and a list of VPLMNs 364a for which the setting is to be considered valid. If the UE is connected to a VPLMN in the VPMMN list and the UE received ANDSF policies from the VPLMN, then the UE may not allow an ISRP from the VPLMN to override IARP mapping when the indication is set, e.g., to TRUE. If the UE is connected to a VPLMN not in the list, the UE may consider the flag set, e.g., to FALSE.

In another example shown in FIG. 3C, the list 364b may be one of a white list or a black list. When the list 364b is configured as a white list, if a VPLMN is a member of the list 364b, then the UE may allow the ISRP from the VPLMN to override IARP mapping, and, if the VPLMN is not a member of the list 364b, then the UE may not allow the ISRP from the VPLMN to override IARP mapping. The list 364b may be included in the IARP 360b provisioned by the HPLMN. This embodiment allows the home operator to specify on a per PLMN basis which VPLMNs are allowed to override IARP mapping by including the VPLMNs in the list 364b. Each VPLMN in the list 364b may be identified by a corresponding VPLMN code. For example, each VLPLMN in the list 364b may be uniquely identified by a unique VPLMN code (e.g., a VPLMN code based on the Mobile Country Code (MCC) and Mobile Network Code (MNC) of the VPLMN).

When the list 364b is configured as a black list, if a VPLMN is a member of the list 364b, then the UE may not allow an ISRP from the VPLMN to override IARP mapping, and, if the VPLMN is not a member of the list 364b, then the UE may allow the ISRP from the VPLMN to override IARP mapping. The list 364b may be included in the IARP 360b provisioned by the HPLMN. This embodiment allows the home operator to specify on a per PLMN basis which VPLMNs are not allowed to override IARP mapping by including the VPLMNs in the list 364b. Each VPLMN in the list 364b may be identified by a corresponding VPLMN code, as discussed above.

In another embodiment, an IARP from the HPLMN may indicate IARP priority on a per filter rule basis. In this embodiment, a filter rule may identify a traffic flow based on a destination address, a destination domain name, an application identity, destination/source port numbers, DSCP or traffic class, etc., and may map the identified traffic flow to an APN or NSWO (when NSWO is available). The IARP may include a plurality of filter rules for different traffic flows (e.g., IP traffic flows). In this embodiment, the IARP may indicate which ones of the filter rules in the IARP have priority over the ISRP from a VPLMN. For example, the IARP may include a flag for each filter rule. In this example, a filter rule having priority over the ISRP may have the corresponding flag set to TRUE, and a filter rule that does not have priority over the ISRP may have the corresponding flag set to FALSE.

For example, if a filter rule maps the corresponding traffic flow (e.g., IP traffic flow) to an APN and the filter rule has priority over the ISRP from a VPLMN, then the ISRP may not move the traffic to NSWO. In another example, if a filter rule maps the corresponding traffic flow (e.g., IP traffic flow) to NSWO and the filter rule has priority over the ISRP from a VPLMN, then the ISRP may not move the traffic to an APN. If a filter rule does not have priority over the ISRP, then the ISRP may be allowed to override mapping by the filter rule.

Thus, this embodiment provides the home operator with the ability to specify on a per filter rule basis which filter rules in the IARP have priority over the ISRP from the VPLMN and which filter rules in the IARP do not have priority over the ISRP (e.g., which filter rules may have their mapping overridden by the ISRP). For example, the home operator may want a filter rule that maps traffic for a particular application to an APN to have priority over ISRP. In this example, the application may require that the traffic be routed through specific APNs to work properly, and may cease to work if the ISRP is allowed to move the traffic to NSWO. In another example, the home operator may want a filter rule that maps certain traffic to NSWO to have priority over ISRP. In this example, the home operator may not want the traffic to use cellular resources or traverse the operator core network.

It is to be appreciated that the IARP may also indicate priority on both a per filter rule basis and a per PLMN basis. For example, an UE may allow an ISRP from a VPLMN to override IARP mapping for a particular data traffic only if both the IARP indicates that the filter rule for the traffic does not have priority over ISRP and the VPLMN is a member of a list of VPLMNs allowed to override IARP mapping.

FIG. 4 illustrates embodiments of methodologies for routing policy evaluation. The method may be performed by a UE (e.g., UE 120), mobile entity, or the like. FIG. 4 illustrates one embodiment of the methodology for routing policy evaluation. The method 400 may include, at 402, receiving, from a home network, a message comprising a home network policy associated with network node routing. For example, the home network policy may include an inter-APN routing policy (IARP) and the home network may be a HPLMN. In this example, the UE may receive the IARP from an H-ANDSF entity in the HPLMN. The H-ANDSF entity may also be referred to as an H-ANDSF server.

The method 400 may include, at 404, receiving, from a visited network, another message comprising a visited network policy associated with network node routing. For example, the visited network policy may include an inter-system routing policy (ISRP) and the visited network may be a VPLMN. In this example, the UE may receive the ISRP from a V-ANDSF entity in the VPLMN.

The method 400 may include, at 406, evaluating the home network policy to determine whether to route data traffic via one of a wireless offload or a designated APN. For example, the UE may locate a filter rule in the home network policy (e.g., IARP) corresponding to the data traffic and route the data traffic according to the filter rule. In this example, the filter rule may indicate that the data traffic is to be routed via the wireless offload (e.g., NSWO) or the designated APN.

The method 400 may include, at 408, evaluating the home network policy to determine whether the home network policy has priority over the visited network policy. For example, the home network policy may comprise a flag indicating whether the home network policy has priority over the visited network policy, and the UE may evaluate the value of the flag (e.g., TRUE/FALSE) to determine whether the home network policy has priority. In this example, the flag may apply to the whole home network policy. In another example, the home network policy may include a list of visited networks that are allowed to override routing of the data traffic by the home network policy. In this example, the UE may determine whether the visited network is in the list of visited networks. If the visited network is not in the list, then the UE may determine that the home network policy has priority. In yet another example, the home network policy may indicate whether the home network policy has priority on a per filter rule basis. In this example, the UE may determine that the home network policy has priority if the home network policy indicates that the filter rule corresponding to the data traffic has priority. It is to be appreciated that the method 400 is not limited to these examples, and that the UE may determine whether the home network policy (e.g., IARP) has priority using any of the methods described herein.

The method 400 may include, at 410, ignoring a rule of the visited network policy associated with routing the data traffic in response to a determination that the home network policy has priority. As a result, the rule of the visited network policy (e.g., ISRP) does not override the routing of the data traffic specified by the home network policy.

With reference to FIG. 5, there is provided an exemplary apparatus 500 that may be configured as a UE, network entity, or other suitable entity, or as a processor, component or similar device for use within the UE, network entity, or other suitable entity, for network node selection. The apparatus 500 may include functional blocks that can represent functions implemented by a processor, software, or combination thereof (e.g., firmware).

As illustrated, in one embodiment, the apparatus 500 may include an electrical component or module 502 for receiving, from a home network, a message comprising a home network policy associated with network node routing. The apparatus 500 may include an electrical component or module 504 for receiving, from a visited network, another message comprising a visited network policy associated with network node routing. The apparatus 500 may include an electrical component or module 506 for evaluating the home network policy to determine whether to route data traffic via one of a wireless offload or a designated APN. The apparatus 500 may include an electrical component or module 508 for evaluating the home network policy to determine whether the home policy network has priority over the visited network policy. The apparatus 500 may include an electrical component or module 510 for ignoring a rule of the visited network policy associated with routing the data traffic in response to a determination that the home network policy has priority.

In related aspects, the apparatus 500 may optionally include a processor component 514 having at least one processor. The processor 514 may be in operative communication with the components 502-510 or similar components via a bus 512 or similar communication coupling. The processor 514 may effect initiation and scheduling of the processes or functions performed by electrical components or modules 502-510.

In further related aspects, the apparatus 500 may include a network interface component 516 for communicating with other network entities. For example, the network interface component 516 may communicate with an ANDSF entity (e.g., H-ANDSF 350a or V-ANDSF 350b) to receive policies (e.g., policies 340a or 340b) from the ANDSF entity. In another example, the network interface communicate 516 may receive data traffic from and/or transmit data traffic to a network node (e.g., WLAN node, eNB, etc.)

The apparatus 500 may optionally include a component for storing information, such as, for example, a memory device/component 518. The computer readable medium or the memory component 518 may be operatively coupled to the other components of the apparatus 500 via the bus 512 or the like. The memory component 518 may be adapted to store computer readable instructions and data for performing the activities of the components 502-510, and subcomponents thereof, or the processor 514. The memory component 518 may retain instructions for executing functions associated with the components 502-510. While shown as being external to the memory 518, it is to be understood that the components 502-510 can exist within the memory 518.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection may be properly termed a computer-readable medium to the extent involving non-transient storage of transmitted signals. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium, to the extent the signal is retained in the transmission chain on a storage medium or device memory for any non-transient length of time. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for routing policy evaluation in a wireless communication system, the method comprising:
receiving, from a home network, a message comprising a home network policy associated with network node routing;
receiving, from a visited network, another message comprising a visited network policy associated with network node routing;
evaluating the home network policy to determine whether to route data traffic via one of a wireless node offload or a designated access point name (APN);
evaluating the home network policy to determine whether the home network policy has priority over the visited network policy; and
ignoring a rule of the visited network policy associated with routing the data traffic in response to a determination that the home network policy has priority.

2. The method of claim 1, wherein the home network policy comprises an indicator flag indicating whether the home network policy has priority, and wherein evaluating the home network policy to determine whether the home network policy has priority is based on the indicator flag.

3. The method of claim 1, wherein the home network policy comprises a list of visited networks, and wherein evaluating the home network policy to determine whether the home network has priority comprises determining whether the visited network is in the list of visited networks.

4. The method of claim 3, wherein evaluating the home network policy to determine whether the home network has priority comprises determining that the home network policy has priority if the visited network is in the list of visited networks.

5. The method of claim 3, wherein evaluating the home network policy to determine whether the home network has priority comprises determining that the home network policy has priority if the visited network is not in the list of visited networks.

6. The method of claim 1, wherein the home network policy comprises an inter-APN routing policy and the visited network policy comprises an inter-system routing policy.

7. The method of claim 1, further comprising allowing the visited network policy to override the routing of the data traffic determined from the home network policy in response to a determination that the home network policy does not have priority.

8. The method of claim 1, wherein the home network policy comprises a plurality of filter rules and one or more indicators indicating which of the plurality of filter rules have priority over the visited network policy, and wherein evaluating the home network policy to determine whether the home network policy has priority comprises:
determining which one of the plurality of filter rules corresponds to the data traffic; and
determining whether the one of the plurality of filter rules has priority over the visited network policy based on at least one of the one or more indicators.

9. The method of claim 8, wherein evaluating the home policy network to determine whether to route the data traffic via one of the wireless offload or the designated APN is based on the one of the plurality of filter rules.

10. The method of claim 1, wherein the home network policy indicates non-seamless wireless local area network (WLAN) offload (NSWO), the method further comprising:
determining, subsequent to ignoring the rule, whether a validity condition of the visited network policy has changed; and
routing the data traffic based on the rule of the visited network in response to determining the validity condition has changed and the rule of the visited network has become valid.

11. An apparatus for routing policy evaluation in a wireless communication system, the apparatus comprising:
means for receiving, from a home network, a message comprising a home network policy associated with network node routing;
means for receiving, from a visited network, another message comprising a visited network policy associated with network node routing;
means for evaluating the home network policy to determine whether to route data traffic via one of a wireless node offload or a designated access point name (APN);
means for evaluating the home network policy to determine whether the home network policy has priority over the visited network policy; and
means for ignoring a rule of the visited network policy associated with routing the data traffic in response to a determination that the home network policy has priority.

12. The apparatus of claim 11, wherein the home network policy comprises an indicator flag indicating whether the home network policy has priority, and wherein the means for evaluating the home network policy to determine whether the home network policy has priority determines whether the home network policy has priority based on the indicator flag.

13. The apparatus of claim 11, wherein the home network policy comprises a list of visited networks, and wherein the means for evaluating the home network policy to determine whether the home network has priority comprises means for determining whether the visited network is in the list of visited networks.

14. The apparatus of claim 13, wherein the means for evaluating the home network policy to determine whether the home network has priority comprises means for determining that the home network policy has priority if the visited network is in the list of visited networks.

15. The apparatus of claim 13, wherein the means for evaluating the home network policy to determine whether the home network has priority comprises means for determining that the home network policy has priority if the visited network is not in the list of visited networks.

16. The apparatus of claim 11, wherein the home network policy comprises an inter-APN routing policy and the visited network policy comprises an inter-system routing policy.

17. The apparatus of claim 11, further comprising means for allowing the visited network policy to override the routing of the data traffic determined from the home network policy in response to a determination that the home network policy does not have priority.

18. The apparatus of claim 11, wherein the home network policy comprises a plurality of filter rules and one or more indicators indicating which of the plurality of filter rules have priority over the visited network policy, and wherein the means for evaluating the home network policy to determine whether the home network policy has priority comprises:
means for determining which one of the plurality of filter rules corresponds to the data traffic; and
means for determining whether the one of the plurality of filter rules has priority over the visited network policy based on at least one of the one or more indicators.

19. The apparatus of claim 18, wherein evaluating the home policy network to determine whether to route the data traffic via one of the wireless offload or the designated APN determines whether to route the data traffic via one of the wireless offload or the designated APN based on the one of the plurality of filter rules.

20. The apparatus of claim 11, wherein the home network policy indicates non-seamless wireless local area network (WLAN) offload (NSWO), the apparatus further comprising:
means for determining, subsequent to ignoring the rule, whether a validity condition of the visited network policy has changed; and
means for routing the data traffic based on the rule of the visited network in response to determining the validity condition has changed and the rule of the visited network has become valid.

21. An apparatus comprising:
transceiver configured to:
receive, from a home network, a message comprising a home network policy associated with network node routing; and
receive, from a visited network, another message comprising a visited network policy associated with network node routing;
at least one processor configured to:
evaluate the home network policy to determine whether to route data traffic via one of a wireless node offload or a designated access point name (APN);
evaluate the home network policy to determine whether the home network policy has priority over the visited network policy; and
ignore a rule of the visited network policy associated with routing the data traffic in response to a determination that the home network policy has priority; and
a memory coupled to the at least one processor for storing data.

22. The apparatus of claim 21, wherein the home network policy comprises an indicator flag indicating whether the home network policy has priority, and wherein the at least one processor is configured to evaluate the home network policy to determine whether the home network policy has priority based on the indicator flag.

23. The apparatus of claim 21, wherein the home network policy comprises a list of visited networks, and wherein the at least one processor is configured to evaluate the home network policy to determine whether the home network has priority by determining whether the visited network is in the list of visited networks.

24. The apparatus of claim 23, wherein the at least one processor is configured to evaluate the home network policy to determine whether the home network has priority by determining that the home network policy has priority if the visited network is in the list of visited networks.

25. The apparatus of claim 23, wherein the at least one processor is configured to evaluate the home network policy to determine whether the home network has priority by determining that the home network policy has priority if the visited network is not in the list of visited networks.

26. The apparatus of claim 21, wherein the home network policy comprises an inter-APN routing policy and the visited network policy comprises an inter-system routing policy.

27. The apparatus of claim 21, wherein the at least one processor is configured to allow the visited network policy to override the routing of the data traffic determined from the home network policy in response to a determination that the home network policy does not have priority.

28. The apparatus of claim 21, wherein the home network policy comprises a plurality of filter rules and one or more indicators indicating which of the plurality of filter rules have priority over the visited network policy, and wherein the at least one processor is configured to evaluate the home network policy to determine whether the home network policy has priority by:
determining which one of the plurality of filter rules corresponds to the data traffic; and
determining whether the one of the plurality of filter rules has priority over the visited network policy based on at least one of the one or more indicators.

29. The apparatus of claim 28, wherein the at least one processor is configured to evaluate the home policy network to determine whether to route the data traffic via one of the wireless offload or the designated APN based on the one of the plurality of filter rules.

30. The apparatus of claim 21, wherein the home network policy indicates non-seamless wireless local area network (WLAN) offload (NSWO), and the at least processor is further configured to:
determine, subsequent to ignoring the rule, whether a validity condition of the visited network policy has changed; and
route the data traffic based on the rule of the visited network in response to determining the validity condition has changed and the rule of the visited network has become valid.

31. A computer program product comprising:
computer-readable medium storing code for causing at least one processor to:
receive, from a home network, a message comprising a home network policy associated with network node routing;
receive, from a visited network, another message comprising a visited network policy associated with network node routing;
evaluate the home network policy to determine whether to route data traffic via one of a wireless node offload or a designated access point name (APN); and
evaluate the home network policy to determine whether the home network policy has priority over the visited network policy; and
ignore a rule of the visited network policy associated with routing the data traffic in response to a determination that the home network policy has priority.

32. The computer program product of claim 31, wherein the home network policy comprises an indicator flag indicating whether the home network policy has priority, and wherein the code for causing the at least one processor to evaluate the home network policy to determine whether the home network policy has priority comprises code for causing the at least one processor to evaluate the home network policy based on the indicator flag.

33. The computer program product of claim 31, wherein the home network policy comprises a list of visited networks, and wherein the code for causing the at least one processor to evaluate the home network policy to determine whether the home network has priority comprises code for causing the at least one processor to determine whether the visited network is in the list of visited networks.

34. The computer program product of claim 33, wherein the code for causing the at least one processor to evaluate the home network policy to determine whether the home network has priority comprises code for causing the at least one processor to determine that the home network policy has priority if the visited network is in the list of visited networks.

35. The computer program product of claim 33, wherein the code for causing the at least one processor to evaluate the home network policy to determine whether the home network has priority comprises code for causing the at least one processor to determine that the home network policy has priority if the visited network is not in the list of visited networks.

36. The computer program product of claim 31, wherein the home network policy comprises an inter-APN routing policy and the visited network policy comprises an inter-system routing policy.

37. The computer program product of claim 31, further comprising code for causing the at least one processor to allow the visited network policy to override the routing of the data traffic determined from the home network policy in response to a determination that the home network policy does not have priority.

38. The computer program product of claim 31, wherein the home network policy comprises a plurality of filter rules and one or more indicators indicating which of the plurality of filter rules have priority over the visited network policy, and wherein the code for causing the at least one processor to evaluate the home network policy to determine whether the home network policy has priority comprises code for causing the at least one processor to:
determine which one of the plurality of filter rules corresponds to the data traffic; and
determine whether the one of the plurality of filter rules has priority over the visited network policy based on at least one of the one or more indicators.

39. The computer program product of claim 38, wherein the code for causing the at least one processor to evaluate the home policy network to determine whether to route the data traffic via one of the wireless offload or the designated APN comprises code for causing the at least one processor to evaluate the home policy network to determine whether to route the data traffic via one of the wireless offload or the designated APN based on the one of the plurality of filter rules.

40. The computer program product of claim 31, wherein the home network policy indicates non-seamless wireless local area network (WLAN) offload (NSWO), and the computer program product further comprises code for causing the at least one processor to:
determine, subsequent to ignoring the rule, whether a validity condition of the visited network policy has changed; and
route the data traffic based on the rule of the visited network in response to determining the validity condition has changed and the rule of the visited network has become valid.
